(19) United States
(12) Patent Application Publication
(10) Pub. No.: US 2024/0229436 A1
(43) Pub. Date: Jul. 11, 2024

(54) EXCESS WATER SLOT WITH FLEXIBLE BENDABLE PIPE FOR WATER SEPARATION

(71) Applicant: Hassan Mohamed S. FRYAN, Riyadh (SA)

(72) Inventor: Hassan Mohamed S. FRYAN, Riyadh (SA)

(21) Appl. No.: 18/578,781

(22) PCT Filed: Jul. 3, 2022
(86) PCT No.: PCT/SA2022/000007

§ 371 Date: Jan. 12, 2024

(30) Foreign Application Priority Data
Jul. 6, 2021 (SA) 121420877

(51) Int. Cl. E03C 1/244; E03C 1/22

(52) U.S. Cl. CPC E03C 1/244; E03C 1/22

(57) ABSTRACT

The current invention provides an excess water slot to be installed in the ordinary slot opening of hand wash basins and in kitchen basins. The slot is provided with a flexible pipe exiting from the middle of the wash basin: The pipe has a suitable height (approximately −/+15 cm high) according to the basin size. The pipe is bendable and foldable to receive unused water flowing from the faucet and leaking's in order to separate water to be ready for recycling before it reaches the middle of the basin and mixes with turbid water: the proposed figure is the (FIG. 1) attached with the drawings below.

### BACKGROUND:

The current invention relates to hand wash basins.

It is well known that there is a need for finding means of saving and recycling water to save fresh water for drinking as fresh water is running short all over the world, For this reason we developed this invention.

US20030046759A1 relates to lavatories and toilets, specifically with regard to combining the two with the options of choosing the temperature of flush water and whether to flush or to drain the lavatory water.

US2010326550A relates to water carrying pipes and in particular to a water saving connector for use with drainpipes, down pipes and the like.

GENERAL DESCRIPTION:

The invention provides a hand wash basin that comprises an excess water slot of flexible pipe protruding up to allow hands inserted between the faucet and the water separation duct to take the faucet water before it falls in the basin to be recycled wherein the excess water slot is fixed to a flexible pipe directed up with an upper funnel for collection leaking and falling water for recycling. None of the cited prior art has cited the above features and the features cited in the claims.

### BRIEF DESCRIPTION OF THE DRAWINGS:

FIG. 1. shows the excess water slot after it is installed in the wash basin.

FIG. 2. shows the parts of the excess water slot in order as installed in the wash basin.

FIG. 3. shows the excess water slot from the bottom and from the upper which will be fixed from the bottom side and the upper side including L figured pipe.

FIG. 4. shows the excess water slot after being installed outside the wash basin.

FIG. 5. shows the upper parts of the fittings with a foldable upper pipe directable to the front, back, and right.

FIG. 6. shows the lower parts of the fittings with an L-figured pipe fixed to the excess water slot at the bottom.

FIG. 7. shows the back side of the hand wash basin.

### DETAILED DESCRIPTION:

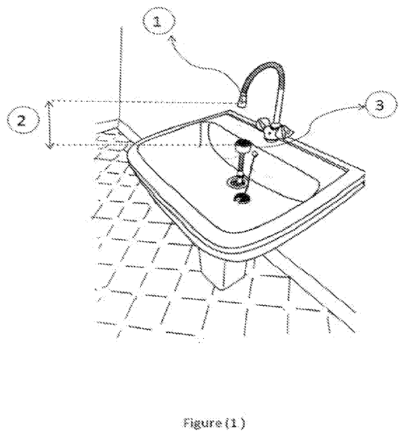

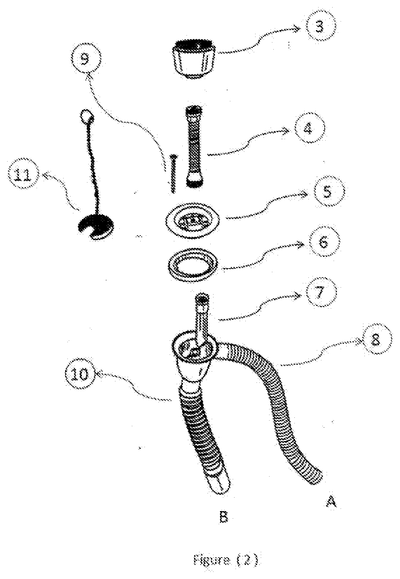

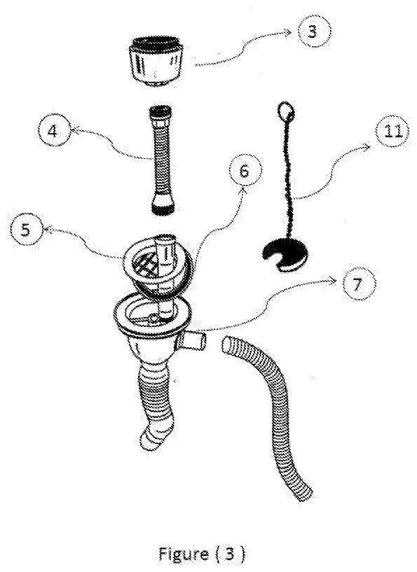

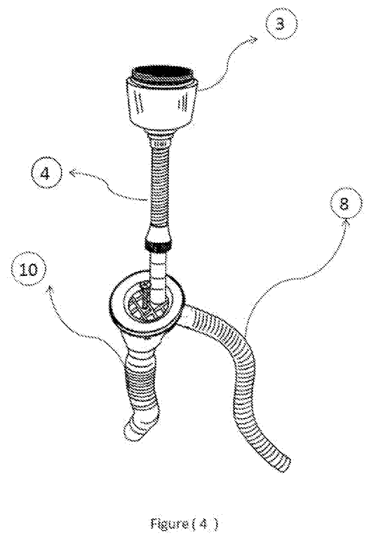

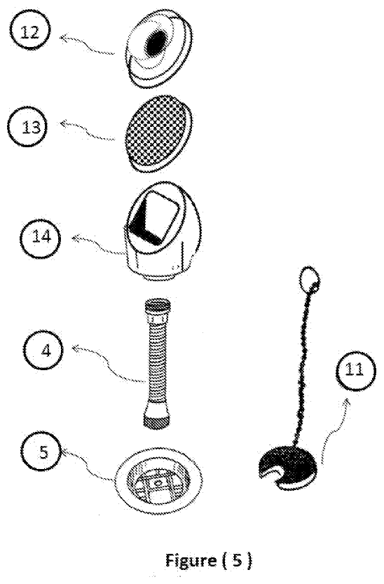

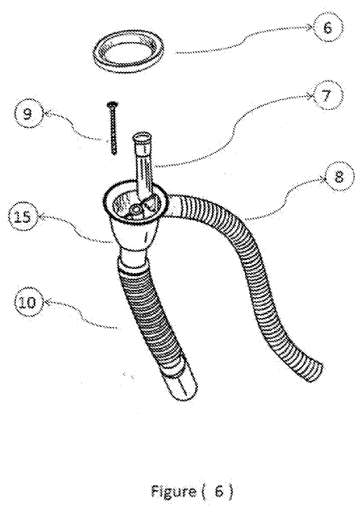

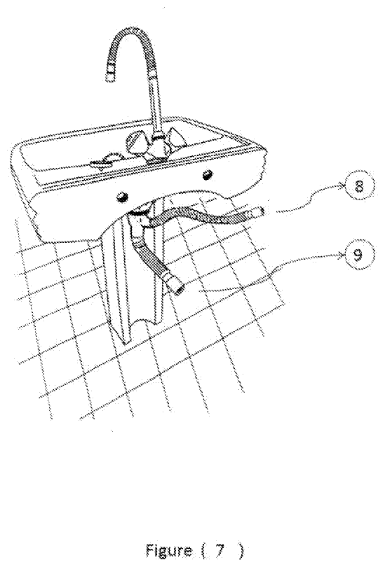

This invention is a system to separate water flowing from faucet to the middle of the hand washbasin or dish wash basin before it reaches the middle of the basin, As shown in FIG. 1 By this invention hands can enter between the faucet and the upper end of the pipe (No. 3 in FIG. 1) and the faucet opening (No 1 in FIG. 1) in order to direct water flowing from the faucet at the time of using the faucet to the direction defined by the user to recycle water, The pipe (No. 3 in FIG. 1) located under the faucet can be moved to any direction in order to allow the user to use the whole basin, This foldable and directable pipe can be inserted from under the basin as shown (in FIG. 7 No. 6), This pipe notably located in the middle of the hand wash basin is designed in “L” shape as shown (in FIG. 7 No. No. 3) to exit its terminal directly through the excess water slot as shown (at FIG. 8 No. 4) in order to collect pure water getting from the faucet and to take it through the excess water slot for recycling as shown in (8 in FIG. 7) while water falling in the middle of the wash basin will be discharged as usual from the slot No. 10 Shown in (figure No. 7) in the upper part of the net and bores to pass it to the public drain system from pipe No. 10 as shown in (FIG. 4); The excess water slot will be fixed by two sets of fixtures one at the upper part and the other at the lower part of the hand wash basin as shown in (FIG. 5.), The second set will be installed at the bottom as shown in (FIG. 6), The two sets will be connected by the bolt shown in No. (9 of figure No. 6) in the two mentioned figures . The set installed in the upper part of the basin consists of 1 funnel of approx. 3 cm diameter to collect water falling from the faucet as shown in No.3 of (FIG. 5) Below it is the foldable pipe No. 4 shown in (FIG. 5) and directable from the right, left, front and back with two serrated upper and lower sides to fix to the pipe inserted from the bottom of the basin as shown in 7 in (FIG. 2), and in 7 of (FIG. 6); In the bottom there is a small circular disc made of stainless metal with suitable bores and with slots to trap impurities. This disc has a big slot to pass the separation pipe to be inserted from the bottom of the basin in (No 5 in FIG. 3) as shown in (5 at FIG. 5.). and bolts (No 9 in FIG. 2) to fix the excess water slot and to connect the upper and lower parts of the slot.

The parts of the excess water slot bottom fixtures are as follows:—As shown in (FIG. 6) at the top of it there is serrated screw no 9 . and (7) is L-shaped pipes fixed to the bottom slot, (6) rubber sealant rings, (15) a small cup- shaped base of the slot opened at the upper and bottom side, places upside down with an L-shaped pipe fixed to the side as shown at (7 in FIG. 6), passing outside the upper part of the excess water slot in the wash basin, It ends with a serrated pipe connecting to the prominent upper pipe in the wash basin and the other terminal is directed to the lower part of the slot and then to the where recycled water can be used; The remaining water of the slot will be drained to the public drain system as shown in No. (10) at (FIG. 7) in the middle of the hand wash basin or dish wash basin.

The beneficial effects of the invention:

The beneficial effect of this invention is to save water by recycling good water again in the easiest way; by getting rid of the very turbid water; this has been clarified by the explanation of the drawings as follows.

(FIG. 1): shows the excess water slot after it is installed in the wash basin as an upper view with the funnel which collects water falling from the faucet and collects water leaking from the faucet for recycling water.
1—faucet outlet.
2—the space between the faucet and the water pipe down of it is for inserting hands for washing.
3—the pipe in Y shape is for recycling fall water.

(FIG. 2): shows the parts of the excess water slot in order as installed in the wash basin:
3—a funnel for receiving and collecting water falling from the faucet;
4—the descending directable and foldable pipe;
5—the pierced disc with a medium opening to pass the pipe from the bottom to the upper situation;
6—Sealant rubber ring;
7—L shaped pipe fixed to the bottom of the slot to pass pure water through the drain pipe of the slot;
8—the lower excess water slot consists of a sleeve to which two pipes are fixed: pipe A for pure water coming from L shaped pipe and pipe B for sewage;
9—Metal screw;
10—Drainage pipe to sewer;
11—Crescent shape rubber stopper to close the excess water slot for special use.

(FIG. 3): a view showing the excess water slot from the bottom and from the upper which will be fixed from the bottom side and the upper side including L figured pipe where a hose is fixed to pass water to the user of recycled water:—
3—funnel to receive water from spigot;
4—flexible tube;
5—small perforated dish;
6—rubber ring; 7—L - shaped tube;
11—Cresscent rubber stopper.

(FIG. 4): a view showing the excess water slot after being installed outside the wash basin: an upper view with the funnel which collects water falling from the faucet and collects water leaking from the faucet for recycling water :
3—a funnel for receiving and collecting falling water;
4—the descending directable and foldable pipe;
8—the lower excess water slot for recycling water;
10—drainage pipe to sewer.

(FIG. 5): a view showing the upper parts of the fittings with a foldable upper pipe directable to the front, back, right :—
3—funnel to receive water from spigot;
4—the descending directable and foldable pipe;
5—small perforated dish;
11—Crescent shape rubber stopper to close the

Excess water slot for special use;
11—A valve to control the diameter of a funnel;
12—Purification sieve;
13—A valve opens when water hits it directly and closes when hands enter upon it.

(FIG. 6): shows the lower parts of the fittings with an L-figured pipe fixed to the excess water slot at the bottom:—
6—rubber ring;
7—an L shape pipe for recycling water;
8—a pipe for recycling water;
9—metal screw;
10—pipe to a sewage system;
15—the main body of the drain slot.

(FIG. 7): a view showing the back side of the hand wash basin:—
8—pipe for recycle good water;
10—pipe for drainage of bad water to sewer.

1. Hand wash basin comprises an excess water slot of flexible pipe protruding up to allow hands inserted between the faucet and the water separation duct to take the faucet water before it falls into the basin to be recycled.

2. The hand wash basin according to claim (1), wherein the excess water slot is fixed to a flexible pipe directed up with an upper funnel for collecting leaking and falling water for recycling.

3. The hand wash basin according to claim (1), wherein the excess water slot comprises (2) two separate outlets in the bottom.

4. The hand wash basin according to claim (1), wherein the Excess water slot further comprises an L-figured pipe fixed to the bottom of the excess water slot to direct the pure water falling in the basin to where the user needs.

5. The hand wash basin according to claim (1), wherein the excess water slot allows entry of pipe for separating water at the bottom and to fix an upper tool to collect the leaking of falling water.

6. The hand wash basin according to claim (1), wherein the excess water slot further comprises two bottom outlets, wherein the first one for turbid water and the other for recyclable pure water.

7. The hand wash basin according to claim (1), wherein the excess water slot is fixed to a flexible pipe directed up with an upper funnel supported optionally with tools of purifications and adjustment of the aperture.
